(19) United States
(12) Patent Application Publication
(10) Pub. No.: US 2010/0082922 A1
(43) Pub. Date: Apr. 1, 2010

(54) VIRTUAL MACHINE MIGRATION USING LOCAL STORAGE

(75) Inventors: Siji Kuruvilla GEORGE, Bangalore (IN); Salil SURI, Bangalore (IN); Vishnu SEKHAR, Bangalore (IN)

Correspondence Address: VMWARE, INC., DARRYL SMITH, 3401 Hillview Ave., PALO ALTO, CA, 94304, US

(73) Assignee: VMWARE, INC., Palo Alto, CA (US)

(21) Appl. No.: 12/274,234

(22) Filed: Nov. 19, 2008

Related U.S. Application Data
(60) Provisional application No. 61/101,428, filed on Sep. 30, 2008.

(51) Int. Cl. G06F 12/14

(52) U.S. Cl. 711/162; 711/E12.103

(57) ABSTRACT

A method, apparatus, and system of virtual machine migration using local storage are disclosed. In one embodiment, a method includes creating a current snapshot of an operating virtual machine on a source physical server, storing a write data on a low-capacity storage device accessible to the source physical server and a destination physical server during a write operation on the destination physical server, and launching the operating virtual machine on the destination physical server when a memory data is copied from the source physical server to the destination physical server. The current snapshot may be a read-only state of the operating virtual machine frozen at a point in time. A time and I/O that may be needed to create the current snapshot that may not increase with a size of the operating virtual machine.

### CLAIM OF PRIORITY AND RELATED APPLICATIONS

This application claims priority on: U.S. Provisional Patent Application No. 61/101,428 titled ‘Methods and Systems for Moving Virtual Machines between Host Computers’ filed Sep. 30, 2008. This application is related to U.S. patent application Ser. No. 12/184,134, filed on Jul. 31, 2008, titled ‘Online Virtual Machine Disk Migration’, U.S. application Ser. No. 12/183,013 titled ‘Method and System for Tracking Data Correspondences’ filed on Jul. 30, 2008, and U.S. application Ser. No. 10/319,217 titled ‘Virtual Machine Migration’ filed on Dec. 12, 2002.

### FIELD OF TECHNOLOGY

This disclosure relates generally to an enterprise method, a technical field of software and/or hardware technology and, in one example embodiment, to virtual machine migration using local storage.

### BACKGROUND

A storage area network (SAN) may be an architecture to attach a remote storage device (e.g., a disk array, a tape library, an optical jukebox, etc.) to a server in such a way that, to an operating system of the server, the remote storage device appears as locally attached. The SAN may be costly and/or complex to implement (e.g., may require purchase of hardware, Fibre Channel host bus adapters, etc.). For example, an organization (e.g., a business, an enterprise, an institution, etc.) may lack resources (e.g., financial, logistical) to implement the SAN to store data related to a live migration of a running virtual machine.

### SUMMARY

In one aspect, a current snapshot of an operating virtual machine is created on a source physical server. A write data is stored on a low-capacity storage device accessible to the source physical server and a destination physical server during a write operation on the destination physical server. The operating virtual machine is launched on the destination physical server when a memory data is copied from the source physical server to the destination physical server.

In another aspect, a system is disclosed. The system includes a source physical server to create a current snapshot of an operating virtual machine and a destination physical server to launch the operating virtual machine on the destination physical server when a memory data is copied from the source physical server to the destination physical server. The system also includes a low-capacity storage device to store a write data accessible to the source physical server and the destination physical server during a write operation on the destination physical server.

In yet another aspect, a machine-readable medium embodying a set of instructions is disclosed. When the set of instructions are executed by a machine, this execution causes the machine to perform a method including creating a current snapshot of an operating virtual machine on a source physical server, storing a write data on a low-capacity storage device accessible to the source physical server and a destination physical server during a write operation on the destination physical server, and launching the operating virtual machine on the destination physical server when a memory data is copied from the source physical server to the destination physical server.

### BRIEF DESCRIPTION OF THE DRAWINGS

Example embodiments are illustrated by way of example and not limitation in the figures of the accompanying drawings, in which like references indicate similar elements and in which:

FIG. 1 is a system view of an operating virtual machine migration using local storage, according to one or more embodiments.

FIG. 2 is an exploded view of a source physical server 104, according to one or more embodiments.

FIG. 3 is a system view of a virtual motion infrastructure and the management modules, according to one or more embodiments.

FIG. 4 is a diagrammatic system view of a data processing system in which any of the embodiments disclosed herein may be performed, according to one or more embodiments.

FIG. 5A is a process flow illustrating the operating virtual machine migration using local storage, according to one or more embodiments.

FIG. 5B is a continuation of process flow of FIG. 5A illustrating additional operations, according to one or more embodiments.

Other features of the present embodiments will be apparent from the accompanying drawings and from the detailed description that follows.

### DETAILED DESCRIPTION

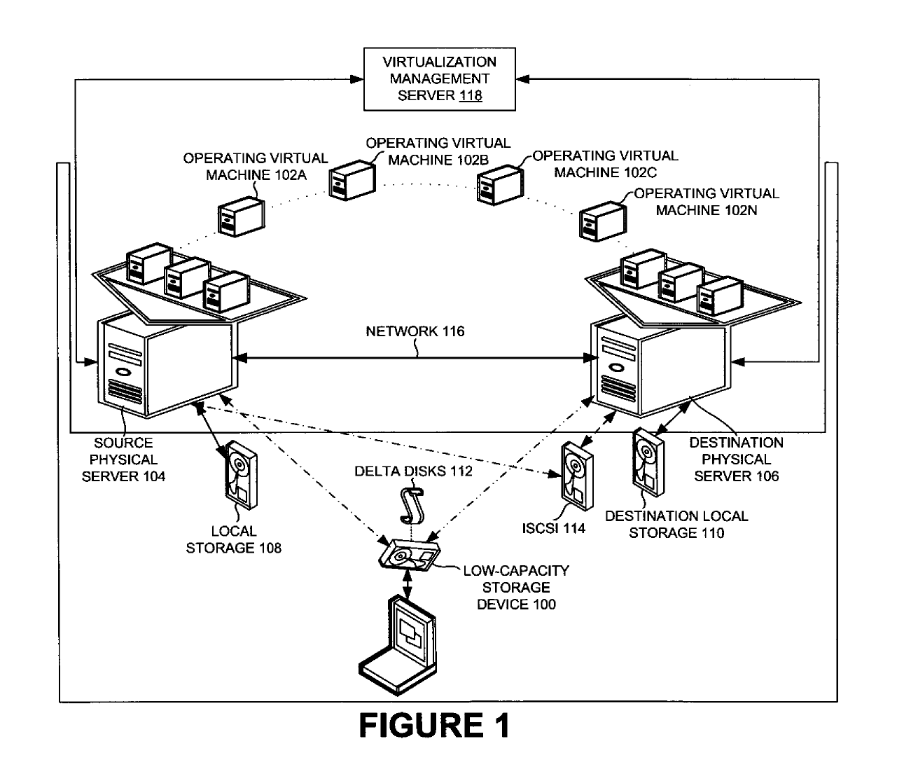

In one embodiment, a method includes creating a current snapshot of an operating virtual machine (e.g., the operating virtual machine 102A-N of FIG. 1) on a source physical server (e.g., the source physical server 104 of FIG. 1), storing a write data on a low-capacity storage device (e.g., the low-capacity storage device 100 FIG. 1) accessible to the source physical server 104 and a destination physical server (e.g., the destination physical server 106 of FIG. 1) during a write operation on the destination physical server 106, and launching the operating virtual machine 102A-N on the destination physical server 106 when a memory data is copied from the source physical server 104 to the destination physical server 106.

In another embodiment, a system includes a source physical server (e.g., the source physical server 104 of FIG. 1) to create a current snapshot of an operating virtual machine (e.g., the operating virtual machine 102A-N of FIG. 1), a destination physical server (e.g., the destination physical server 106 of FIG. 1) to launch the operating virtual machine 102A-N on the destination physical server 106 when a memory data is copied from the source physical server 104 to the destination physical server 106, and a low-capacity storage device (e.g., the low-capacity storage device 100 FIG. 1) to store a write data accessible to the source physical server 104 and the destination physical server 106 during a write operation on the destination physical server 106.

In yet another embodiment, a machine-readable medium embodying a set of instructions that, when executed by a machine, causes the machine to perform a method that includes creating a current snapshot of an operating virtual machine (e.g., the operating virtual machine 102A-N of FIG. 1) on a source physical server (e.g., the source physical server 104 of FIG. 1), storing a write data on a low-capacity storage device (e.g., the low-capacity storage device 100 FIG. 1) accessible to the source physical server 104 and a destination physical server (e.g., the destination physical server 106 of FIG. 1) during a write operation on the destination physical server 106, launching the operating virtual machine 102A-N on the destination physical server 106 when a memory data is copied from the source physical server 104 to the destination physical server 106.

FIG. 1 is a system view of an operating virtual machine migration using local storage, according to one embodiment. Particularly, FIG. 1 illustrates, a low-capacity storage device 100, an operating virtual machine 102A-N, a source physical server 104, a destination physical server 106, a local storage 108, a destination local storage 110, a delta disks 112, an Internet Small System Interface (iSCSI) 114, a network 116, and a virtualization management server 118, according to one embodiment.

The low-capacity storage device 100 may be a device for holding programs and/or data. The low-capacity storage device 100 (e.g., a Network Attached Storage (NAS) device, an iSCSI target, a Network File System (NFS) device, a Common Internet File System (CIFS) device, etc.) may be temporary (e.g., memory with the computer) or permanent (e.g., disk storage) that is approximately between 5 gigabytes and 10 gigabytes in capacity.

The operating virtual machine 102A-N may be a type of computer application (e.g., hardware operating virtual machine software) that may be used to create a virtual environment (e.g., virtualization) that may be used to run multiple operating systems at the same time. The source physical server 104 may be a processing unit (e.g., a bare metal hypervisor, etc.) that may represent a complete system with processors, memory, networking, storage and BIOS. The destination physical server 106 may be another processing unit that may launch the operating virtual machine and copy the memory data from the local storage 108 of the source physical server 104 through a network 116.

The local storage 108 may be a device that may hold the data (e.g., the VMDK files) which are the actual virtual hard drives for the virtual guest operation system (e.g., operating virtual machine) and may also stores the contents of the operating virtual machine's hard disk drive. The destination local storage 110 may be the device that may hold the data of the destination physical server. The delta disks 112 may be the files that are stored in the low-capacity storage device 100. The changes done in the local storage 108, after taking the snapshot of the disk (e.g., the actual virtual hard drives) are considered as the delta disks files.

The Internet Small System Interface (iSCSI) 114 may be an Internet Protocol (IP) which is based on storage networking standard for linking data storage facilities. The network 116 may connect a number of data processing unit (e.g., the computers) to each other and/or to a central server so that the devices connected (e.g., the computers) can share programs and/or files. The virtualization management server 118 may be a virtual center that may provide the operating virtual machines 102A-N and may also monitor the performance of physical servers (e.g., the source physical server 104 and the destination physical server 106) and operating virtual machines 102A-N.

In an example embodiment, the low-capacity storage device 100 may include the delta disks 112. The source physical server 104 may include the local storage 108. The destination physical server 110 may include the local storage 110. The source physical server 104 may be connected to the destination physical server 106 through the network 116. The operating virtual machine 102A-N may be migrated from the source physical server 104 to the destination physical server 106. The virtualization management server 118 may be connected to the source physical server 104 and the destination physical server 106.

In one embodiment, the current snapshot of the operating virtual machine 102A-N may be created on the source physical server 104. The write data may be stored on the low-capacity storage device 100 accessible to the source physical server 104 and the destination physical server during a write operation on the destination physical server 106. The operating virtual machine 102A-N may be launched on the destination physical server 106 when a memory data is copied from the source physical server 104 to the destination physical server 106. The current snapshot may be a read-only state of the operating virtual machine 102A-N frozen at a point in time.

A time and I/O may be needed to create the current snapshot that may not increase with a size of the operating virtual machine 102A-N. The memory data may be copied from the local storage 108 of the source physical server 104 to the destination physical server 106 through the network 116. The source checkpoint may be placed when creating the current snapshot. The execution of the operating virtual machine 102A-N may be restarted using the source checkpoint in case of failure. The user may be simulated such that a migration of the operating virtual machine 102 A-N between the source physical server 104 and the destination physical server 106 is complete when a read operation points to the local storage of the source physical server 104. The local storage 108 of the source physical server 104 may be accessed through an Internet Small System Interface (iSCSI) (e.g., the Internet Small System Interface (iSCSI) 114 of FIG. 1) target on the destination physical server 106. The delta snapshot of the write data may be created. The delta snapshot may be placed on one of the low-capacity storage device 100 and the destination physical server 106. The write data may be a delta disks data processed after the current snapshot of the operating virtual machine 102A-N.

The write operation may be a transfer of the current snapshot of the operating virtual machine 102A-N from the source physical server 104 to the destination physical server 106. The low-capacity storage device 100 may be approximately between 5 gigabytes and 10 gigabytes in capacity. The low-capacity storage device 100 may be a Network Attached Storage (NAS) device, an iSCSI target 114, a Network File System (NFS) device, and a Common Internet File System (CIFS) device. The low-capacity storage device 100 may be an iSCSI target 114 on the local storage 108 of the source physical server 104 so that the write data resides on a same data store as the operating virtual machine 102A-N. The low-capacity storage device 100 may be a mount point on one of a virtualization management server (e.g., the virtualization management server 118 of FIG. 1).

The source physical server 104 may create a current snapshot of an operating virtual machine (e.g., the operating virtual machine 102A-N of FIG. 1). The destination physical server 106 may launch the operating virtual machine 102A-N on the destination physical server 106 when a memory data is copied from the source physical server 104 to the destination physical server 106.

The low-capacity storage device 100 may store a write data accessible to the source physical server 104 and the destination physical server 106 during a live migration of a virtual machine between the source physical server 104 and the destination physical server 106 without disruption to an operating session of the virtual machine. The current snapshot may be a read-only state of the operating virtual machine 102A-N frozen at a point in time. The time and I/O needed to create the current snapshot may not increase with a size of the operating virtual machine 102A-N. The memory data may be copied from the local storage 108 of the source physical server 104 to the destination physical server 106 through the network 116.

The source checkpoint may be placed when creating the current snapshot. The execution of the operating virtual machine 102A-N may be restarted using the source checkpoint in case of failure. The migration of the operating virtual machine 102A-N between the source physical server 104 and the destination physical server 106 may be simulated to a user when a read operation points to the local storage 108 of the source physical server 104. The local storage 108 of the source physical server 104 may be accessed through an iSCSI target 114 on the destination physical server 106.

The delta snapshot of the write data may be created. The delta snapshot may be placed on one of the low-capacity storage device 100 and the destination physical server 106.

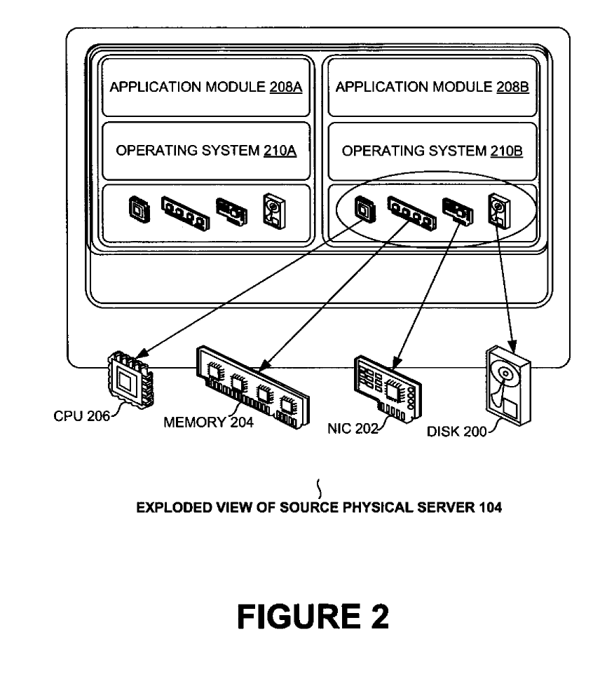

FIG. 2 is an exploded view of a source physical server, according to one embodiment. Particularly, FIG. 2 illustrates a disk 200, a NIC 202, a memory 204, a CPU 206, an application module 208 and an operating system 210, according to one embodiment.

The disk 200 may be the actual virtual hard drive for the virtual guest operation system (e.g., operating virtual machine) and may store the contents of the operating virtual machine's hard disk drive. The disk (e.g., the virtual disk, the base disk) may be made up of one or more base disk files (e.g., vmdk files). The NIC 202 may be an expansion board that may be inserted into a data processing unit (e.g., computer) so the data processing unit (e.g., the computer) can be connected to the network 116. The memory 204 may be the storage device (e.g., the internal storage) in the data processing unit (e.g., the computer, the source physical server 104) and/or may be identified as the data storage that comes in the form of chips. The CPU 206 may be central processing unit (CPU) and/or the processor is defined as the component in a digital computer that interprets instructions and processes data contained in computer programs. The application module 208 may be a software designed to process data and support users in an organization (e.g., the virtual environment). The operating system 210 may be the software program that may share the computer system's resources (e.g., processor, memory, disk space, network bandwidth, etc.) between users and the application programs they run and/or controls access to the system to provide security.

In an example embodiment, the source physical server 104 may include the operating virtual machine may include the disk 200, the NIC 202, the memory 204, CPU 206, the application module 208 and/or the operating system 210.

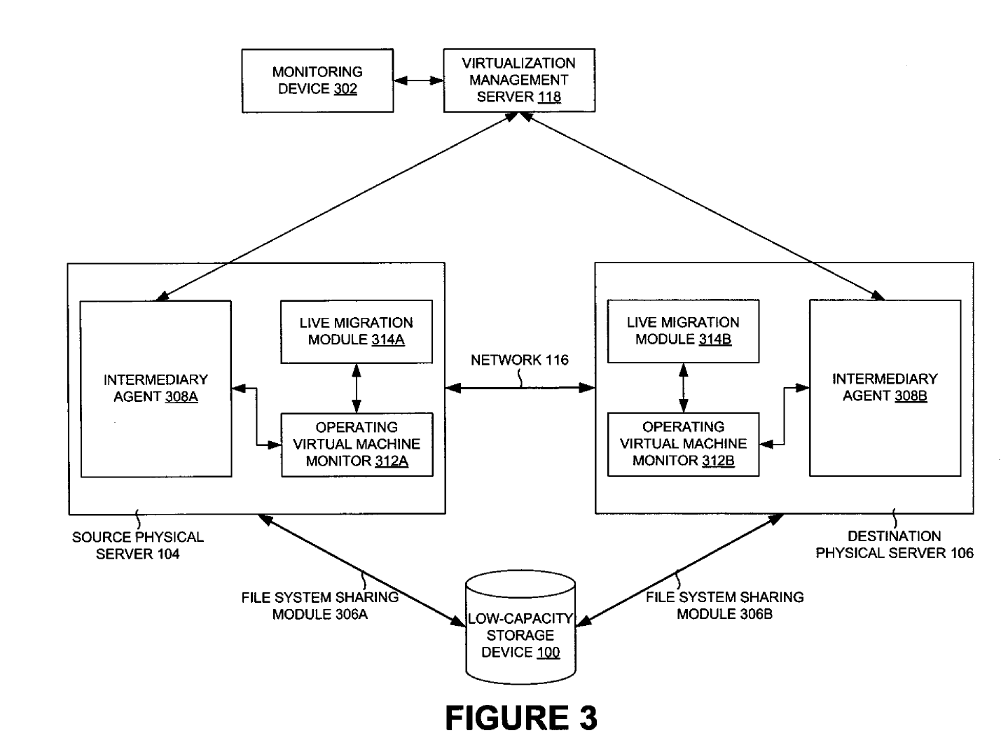

FIG. 3 is a system view of the virtual motion infrastructure and the management modules, according to one embodiment. Particularly, FIG. 3 illustrates a monitoring device 302, a file system sharing module 306A-B, an intermediary agent 308A-B, an operating virtual machine monitor 312A-B, a live migration module 314A-B, the source physical server 104, the destination physical server 106, the network 116, low capacity storage device 100 and the virtualization management server 118, according to one embodiment.

The monitoring device 302 (e.g., the DRS) may continuously monitor utilization across resource pools and intelligently allocates available resources among the operating virtual machines 102A-N based on pre-defined rules that reflect business needs and changing priorities. The file system sharing module 306A-B (e.g., the Network Attached Storage (NAS) device, the iSCSI target, the Network File System (NFS) device, the Common Internet File System (CIFS) device, etc.) may provide and reception of digital files over the network 116 where the files are stored and served by physical servers (e.g., the source physical 104, the destination physical server 106, etc.) and the users.

The intermediary agent 308A-B (e.g., the vpxa) may be a process agent used to connect to virtualization management server 118 (e.g., the virtual center). The intermediary agent 308A-B may run as a special system user (e.g., the vpxuser) and may act as the intermediary between the programmable interface (e.g., the hostd agent) and the virtualization management server 118 (e.g., the Virtual Center). The programmable interface may be the process that authenticates users and keeps track of which users and groups have which privileges and also allows creating and managing local users. The programmable interface (e.g., the hostd process) may provide a programmatic interface to VM kernel and is used by direct client connections as well as the API.

The operating virtual machine monitor 312A-B may be the process that provides the execution environment for an operating virtual machine. The live migration module 314A-B may be a state-of-the-art solution that enables to perform live migration of operating virtual machine disk files across heterogeneous storage arrays with complete transaction integrity and no interruption in service for critical applications.

In an example embodiment, the virtualization management server 118 may be connected to the monitoring device 302, the source physical server 104 and the destination physical server 106. The source physical server 104 may include the intermediary agent 308A, the programmable interface 310A, the operating virtual machine monitor 312A and the live migration module 314A-B. The destination physical server 106 may include the intermediary agent 308B, the programmable interface 310B, the operating virtual machine monitor 312B and the live migration module 314A-B. The source physical server 104 and the destination physical server may be connected with the network 116. The storage system 304 may be connected to the source physical server 104 and the destination physical server 106 with the file system sharing module 306A-B.

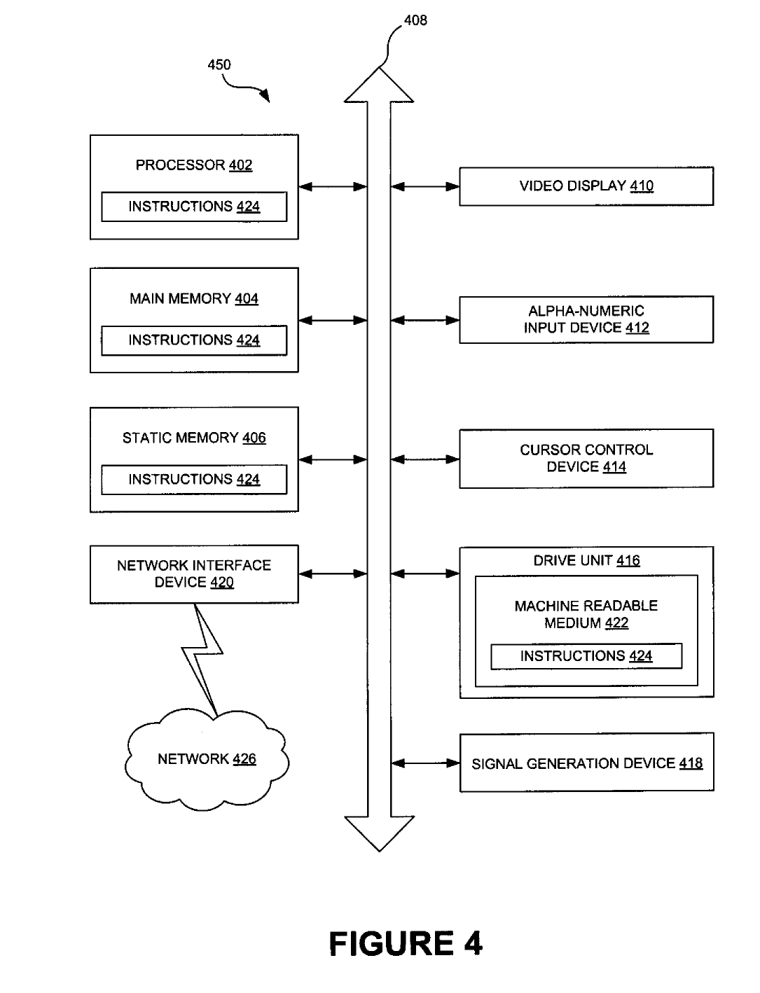

FIG. 4 is a diagrammatic system view of a data processing system in which any of the embodiments disclosed herein may be performed, according to one embodiment. Particularly, the diagrammatic system view 400 of FIG. 4 illustrates a processor 402, a main memory 404, a static memory 406, a bus 408, a video display 410, an alpha-numeric input device 412, a cursor control device 414, a drive unit 416, a signal generation device 418, a network interface device 420, a machine readable medium 422, instructions 424, and a network 426, according to one embodiment.

The diagrammatic system view 400 may indicate a personal computer and/or the data processing system in which one or more operations disclosed herein are performed. The processor 402 may be a microprocessor, a state machine, an application specific integrated circuit, a field programmable gate array, etc. (e.g., Intel® Pentium® processor). The main memory 404 may be a dynamic random access memory and/or a primary memory of a computer system.

The static memory 406 may be a hard drive, a flash drive, and/or other memory information associated with the data processing system. The bus 408 may be an interconnection between various circuits and/or structures of the data processing system. The video display 410 may provide graphical representation of information on the data processing system. The alpha-numeric input device 412 may be a keypad, a keyboard and/or any other input device of text (e.g., a special device to aid the physically handicapped).

The cursor control device 414 may be a pointing device such as a mouse. The drive unit 416 may be the hard drive, a storage system, and/or other longer term storage subsystem. The signal generation device 418 may be a bios and/or a functional operating system of the data processing system. The network interface device 420 may be a device that performs interface functions such as code conversion, protocol conversion and/or buffering required for communication to and from the network 426. The machine readable medium 422 may provide instructions on which any of the methods disclosed herein may be performed. The instructions 424 may provide source code and/or data code to the processor 402 to enable any one or more operations disclosed herein.

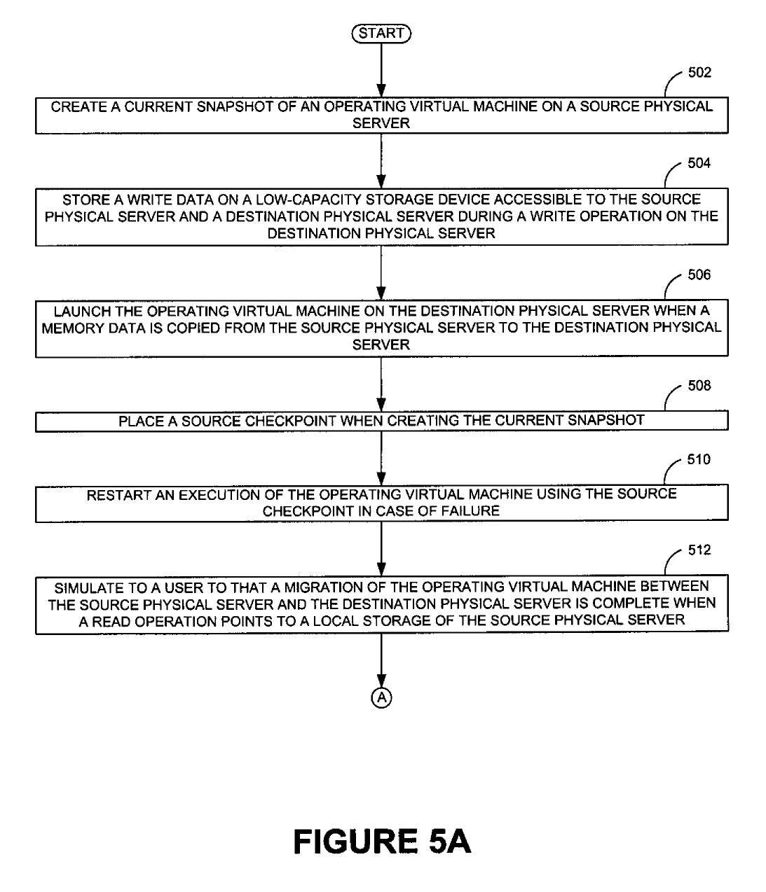

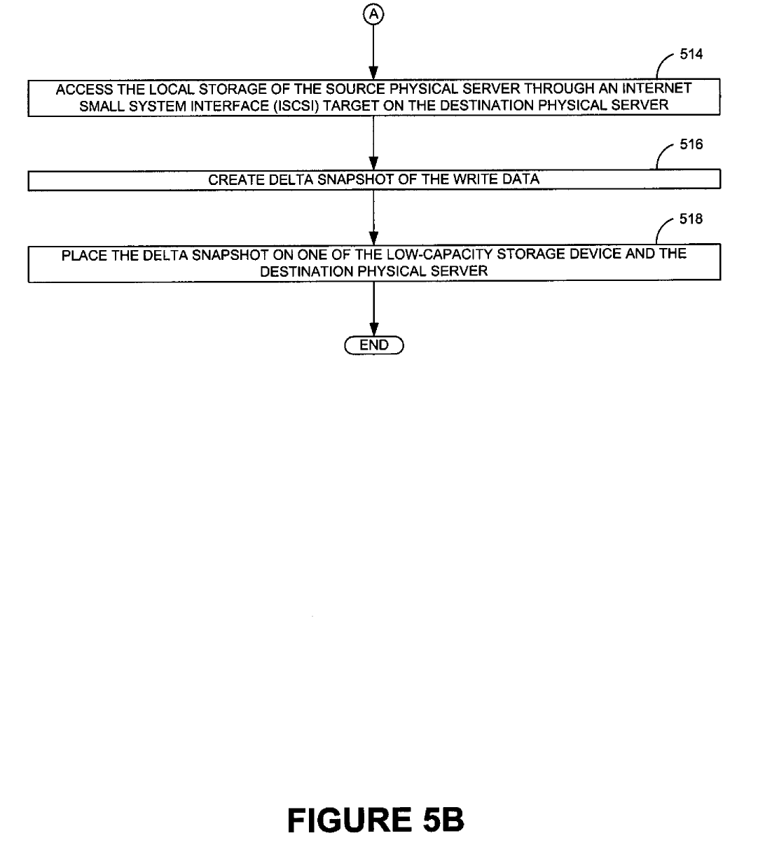

FIG. 5A is a process flow illustrating an operating virtual machine migration using local storage, according to one embodiment. In operation 502, a current snapshot of an operating virtual machine (e.g., the operating virtual machine 102A-N of FIG. 1) may be created on a source physical server (source physical server 104 FIG. 1). In operation 504, a write data may be stored on a low-capacity storage device (e.g., the low-capacity storage device of FIG. 1) accessible to the source physical server 104 and a destination physical server (e.g., the destination physical server 106 of FIG. 1) during a write operation on the destination physical server 106.

In operation 506, the operating virtual machine 102A-N may be launched on the destination physical server 106 when a memory data is copied from the source physical server 104 to the destination physical server 106. The current snapshot may be a read-only state of the operating virtual machine 102A-N frozen at a point in time. A time and I/O may be needed to create the current snapshot that does not increase with a size of the operating virtual machine 102A-N. The memory data may be copied from a local storage (e.g., the local storage 108 of FIG. 1) of the source physical server 104 to the destination physical server 106 through a network (e.g., the network 116 of FIG. 1).

In operation 508, a source checkpoint may be placed when creating the current snapshot. In operation 510, an execution of the operating virtual machine 102A-N may be restarted using the source checkpoint in case of failure. In operation 512, a user may be simulated that a migration of the operating virtual machine 102A-N between the source physical server 104 and the destination physical server 106 is complete when a read operation points to the local storage of the source physical server 104.

FIG. 5B is a continuation of process flow of FIG. 5A illustrating additional operations, according to one embodiment. In operation 514, the local storage 108 of the source physical server 104 may be accessed through an Internet Small System Interface (iSCSI) (e.g., the Internet Small System Interface (iSCSI) 114 of FIG. 1) target on the destination physical server 106. In operation 516, a delta snapshot of the write data may be created. In operation 518, the delta snapshot may be placed on one of the low-capacity storage device 100 and the destination physical server 106. The write data may be a delta disks data processed after the current snapshot of the operating virtual machine. The write operation may be a transfer of the current snapshot of the operating virtual machine 102A-N from the source physical server 104 to the destination physical server 106. The low-capacity storage device 100 may be approximately between 5 gigabytes and 10 gigabytes in capacity. The low-capacity storage device 100 may be a Network Attached Storage (NAS) device, an iSCSI target 114, a Network File System (NFS) device, and a Common Internet File System (CIFS) device. The low-capacity storage device 100 may be an iSCSI target 114 on the local storage 108 of the source physical server 104 so that the write data resides on a same data store as the operating virtual machine 102A-N. The low-capacity storage device 100 may be a mount point on one of a virtualization management server (e.g., the virtualization management server 118 of FIG. 1).

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry (e.g., CMOS based logic circuitry), firmware, software and/or any combination of hardware, firmware, and/or software (e.g., embodied in a machine readable medium). For example, the various electrical structure and methods may be embodied using transistors, logic gates, and electrical circuits (e.g., application specific integrated (ASIC) circuitry and/or in Digital Signal Processor (DSP) circuitry).

Particularly, the low-capacity storage device 100, the operating virtual machine 102A-N, the source physical server 104, the destination physical server 106, the local storage 108, the destination local storage 110, the delta disks 112, the Internet Small System Interface (iSCSI)114 and the network 116 FIG. 1, the disk 200, the NIC 202, the memory 204, and the CPU 206 of FIG. 2, and the monitoring device 302, the file system sharing module 306A-B, the intermediary agent 308A-B, the operating virtual machine monitor 312A-B, the live migration module 314A-B, of FIG. 3 may be enabled using a low-capacity storage circuit, an operating virtual machine circuit, a source physical server circuit, a destination physical server circuit, a local storage circuit, a destination local storage circuit, a delta disks circuit, an Internet Small System Interface (iSCSI) circuit, a network circuit, a disk circuit, a NIC circuit, a memory circuit, a CPU circuit, a virtualization management server circuit, a monitoring device circuit, a storage circuit, a file system sharing circuit, a intermediary agent circuit, an operating virtual machine monitor circuit, a live migration module circuit, and other circuits.

In one or more embodiments, programming instructions for executing above described methods and systems are provided. The programming instructions are stored in a computer readable media.

With the above embodiments in mind, it should be understood that one or more embodiments of the invention may employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing.

Any of the operations described herein that form part of one or more embodiments of the invention are useful machine operations. One or more embodiments of the invention also relates to a device or an apparatus for performing these operations. The apparatus may be specially constructed for the required purposes, such as the carrier network discussed above, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The programming modules and software subsystems described herein can be implemented using programming languages such as Flash, JAVA™, C++, C, C#, Visual Basic, JavaScript, PHP, XML, HTML etc., or a combination of programming languages. Commonly available protocols such as SOAP/HTTP may be used in implementing interfaces between programming modules. As would be known to those skilled in the art the components and functionality described above and elsewhere herein may be implemented on any desktop operating system such as different versions of Microsoft Windows, Apple Mac, Unix/X-Windows, Linux, etc., executing in a virtualized or non-virtualized environment, using any programming language suitable for desktop software development.

The programming modules and ancillary software components, including configuration file or files, along with setup files required for providing the method and apparatus for troubleshooting subscribers on a telecommunications network and related functionality as described herein may be stored on a computer readable medium. Any computer medium such as a flash drive, a CD-ROM disk, an optical disk, a floppy disk, a hard drive, a shared drive, and storage suitable for providing downloads from connected computers, could be used for storing the programming modules and ancillary software components. It would be known to a person skilled in the art that any storage medium could be used for storing these software components so long as the storage medium can be read by a computer system.

One or more embodiments of the invention may be practiced with other computer system configurations including hand-held devices, microprocessor systems, microprocessor-based or programmable consumer electronics, minicomputers, mainframe computers and the like. The invention may also be practiced in distributing computing environments where tasks are performed by remote processing devices that are linked through a network.

One or more embodiments of the invention can also be embodied as computer readable code on a computer readable medium. The computer readable medium is any data storage device that can store data, which can thereafter be read by a computer system. Examples of the computer readable medium include hard drives, network attached storage (NAS), read-only memory, random-access memory, CD-ROMs, CD-Rs, CD-RWs, DVDs, Flash, magnetic tapes, and other optical and non-optical data storage devices. The computer readable medium can also be distributed over a network coupled computer systems so that the computer readable code is stored and executed in a distributed fashion.

While one or more embodiments of the present invention have been described, it will be appreciated that those skilled in the art upon reading the specification and studying the drawings will realize various alterations, additions, permutations and equivalents thereof. It is therefore intended that embodiments of the present invention include all such alterations, additions, permutations, and equivalents as fall within the true spirit and scope of the invention as defined in the following claims. Thus, the scope of the invention should be defined by the claims, including the full scope of equivalents thereof.

What is claimed is:

1. A method, comprising:
creating a current snapshot of an operating virtual machine on a source physical server;
storing a write data on a low-capacity storage device accessible to the source physical server and a destination physical server during a write operation on the destination physical server; and
launching the operating virtual machine on the destination physical server when a memory data is copied from the source physical server to the destination physical server.

2. The method of claim 1:
wherein the current snapshot is a read-only state of the operating virtual machine frozen at a point in time,
wherein a time and I/O needed to create the current snapshot does not increase with a size of the operating virtual machine, and
wherein the memory data is copied from a local storage of the source physical server to the destination physical server through a network.

3. The method of claim 2 further comprising:
placing a source checkpoint when creating the current snapshot; and
restarting an execution of the operating virtual machine using the source checkpoint in case of failure.

4. The method of claim 1 further comprising:
simulating to a user to that a migration of the operating virtual machine between the source physical server and the destination physical server is complete when a read operation points to a local storage of the source physical server; and
accessing the local storage of the source physical server through an Internet Small System Interface (iSCSI) target on the destination physical server.

5. The method of claim 4 further comprising:
creating at least one delta snapshot of the write data; and
placing the at least one delta snapshot on one of the low-capacity storage device and the destination physical server.

6. The method of claim 1:
wherein the write data is a delta disks data processed after the current snapshot of the operating virtual machine, and
wherein the write operation is a transfer of the current snapshot of the operating virtual machine from the source physical server to the destination physical server.

7. The method of claim 1 wherein the low-capacity storage device is approximately between 5 gigabytes and 10 gigabytes in capacity.

8. The method of claim 7 wherein the low-capacity storage device is at least one of a Network Attached Storage (NAS) device, an iSCSI target, a Network File System (NFS) device, and a Common Internet File System (CIFS) device.

9. The method of claim 8 wherein the low-capacity storage device is an iSCSI target on a local storage of the source physical server so that the write data resides on a same data store as the operating virtual machine.

10. The method of claim 7 wherein the low-capacity storage device is a mount point on one of a virtualization management server and the source physical server.

11. A system, comprising:
a source physical server to create a current snapshot of an operating virtual machine;
a destination physical server to launch the operating virtual machine on the destination physical server when a memory data is copied from the source physical server to the destination physical server; and
a low-capacity storage device to store a write data accessible to the source physical server and the destination physical server during a live migration of a virtual machine between the source physical server and the destination physical server without disruption to an operating session of the virtual machine.

12. The system of claim 11:
wherein the current snapshot is a read-only state of the operating virtual machine frozen at a point in time,
wherein a time and I/O needed to create the current snapshot does not increase with a size of the operating virtual machine, and
wherein the memory data is copied from a local storage of the source physical server to the destination physical server through a network.

13. The system of claim 12:
wherein a source checkpoint is placed when creating the current snapshot, and
wherein an execution of the operating virtual machine is restarted using the source checkpoint in case of failure.

14. The system of claim 11:
wherein a migration of the operating virtual machine between the source physical server and the destination physical server is simulated to a user when a read operation points to a local storage of the source physical server, and
wherein the local storage of the source physical server is accessed through an iSCSI target on the destination physical server.

15. The system of claim 14 wherein:
at least one delta snapshot of the write data is created, and
wherein the at least one delta snapshot is placed on one of the low-capacity storage device and the destination physical server.

16. A machine-readable medium embodying a set of instructions that, when executed by a machine, causes the machine to perform a method comprising:
creating a current snapshot of an operating virtual machine on a source physical server;
storing a write data on a low-capacity storage device accessible to the source physical server and a destination physical server during a write operation on the destination physical server; and
launching the operating virtual machine on the destination physical server when a memory data is copied from the source physical server to the destination physical server.

17. The machine-readable medium of claim 16:
wherein the current snapshot is a read-only copy of the operating virtual machine frozen at a point in time,
wherein a time and I/O needed to create the current snapshot does not increase with a size of the operating virtual machine, and
wherein the memory data is copied from a local storage of the source physical server to the destination physical server through a network.

18. The machine-readable medium of claim 17 further comprising:
placing a source checkpoint when creating the current snapshot; and
restarting an execution of the operating virtual machine using the source checkpoint in case of failure.

19. The machine-readable medium of claim 16 further comprising:
simulating to a user to that a migration of the operating virtual machine between the source physical server and the destination physical server is complete when a read operation points to a local storage of the source physical server; and
accessing the local storage of the source physical server through an Internet Small System Interface (iSCSI) target on the destination physical server.

20. The machine-readable medium of claim 19 further comprising:
creating at least one delta snapshot of the write data; and
placing the at least one delta snapshot on one of the low-capacity storage device and the destination physical server.
